(19) United States
(12) Patent Application Publication
(10) Pub. No.: US 2021/0013919 A1
(43) Pub. Date: Jan. 14, 2021

(54) Antenna integration capable of receiving wireless signals

(71) Applicant: JTS PROFESSIONAL CO., LTD., Taichung (TW)

(72) Inventor: Ming-Cheng CHUNG, Taichung (TW)

(21) Appl. No.: 16/505,677

(22) Filed: Jul. 8, 2019

(51) Int. Cl. H04B 1/40; H04R 25/00; H04B 1/3827; H01Q 21/28

(52) U.S. Cl. CPC H04B 1/40; H04R 25/554; H04R 2420/07; H01Q 21/28; H04B 1/3833

(57) ABSTRACT

An antenna integration is applicable for a wireless microphone, a wireless teaching system, and a wireless tour guide system of ultra-high frequencies. The antenna integration contains an antenna integrator including: multiple antenna input ends, a power control module, multiple radio frequency (RF) attenuations, and multiple radio frequency (RF) input ons/offs. The multiple antenna input ends are arranged in the antenna integrator and are configured to input radio frequency (RF) signals of multiple pairs of antennas. The power control module is arranged in the antenna integrator and is configured to turn on/off a power supply to the multiple pairs of antennas. The multiple radio frequency (RF) attenuations are arranged in the antenna integrator and are configured to control an input of the RF signals. The multiple radio frequency (RF) input ons/offs are arranged in the antenna integrator and are configured to turn on/off the RF signals.

### FIELD OF THE INVENTION

The present invention relates to an antenna integration which is capable of receiving wireless signals (i.e., the RF signals) sufficiently.

### BACKGROUND OF THE INVENTION

A conventional wireless audio receiver is applicable for a wireless microphone, a wireless teaching system or a wireless tour guide system, but its antenna cannot receive wireless signals (i.e., the RF signals) widely.

The present invention has arisen to mitigate and/or obviate the afore-described disadvantages.

### SUMMARY OF THE INVENTION

The primary objective of the present invention is to provide an antenna integration which is capable of receiving wireless signals (i.e., the RF signals) sufficiently.

Another objective of the present invention is to provide an antenna integration by which the RF signals are declined easily and quickly by ways of the multiple RF input ons/offs and the multiple RF attenuations.

To obtain above-mentioned objective, an antenna integration provided by the present invention is applicable for a wireless microphone, a wireless teaching system, and a wireless tour guide system of ultra-high frequencies.

The antenna integration contains an antenna integrator including: multiple antenna input ends, a power control module, multiple radio frequency (RF) attenuations, and multiple radio frequency (RF) input ons/offs.

The multiple antenna input ends are arranged in the antenna integrator and are configured to input radio frequency (RF) signals of multiple pairs of antennas.

The power control module is arranged in the antenna integrator and is configured to turn on/off a power supply to the multiple pairs of antennas.

The multiple radio frequency (RF) attenuations are arranged in the antenna integrator and are configured to control an input of the RF signals.

The multiple radio frequency (RF) input ons/offs are arranged in the antenna integrator and are configured to turn on/off the RF signals.

### BRIEF DESCRIPTION OF THE DRAWINGS

FIG. 1 is a schematic diagram showing the assembly of antenna integration according to a first embedment of the present invention.

FIG. 2 is a circuit diagram showing the assembly of the antenna integration according to the first embedment of the present invention.

FIG. 3 is another circuit diagram showing the assembly of the antenna integration according to the first embedment of the present invention.

FIG. 4 is a schematic diagram showing the assembly of antenna integration according to a second embedment of the present invention.

### DETAILED DESCRIPTION OF THE PREFERRED EMBODIMENTS

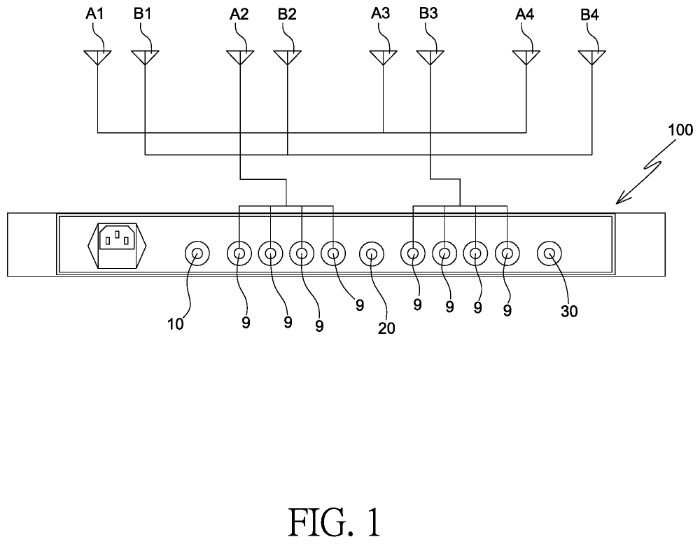

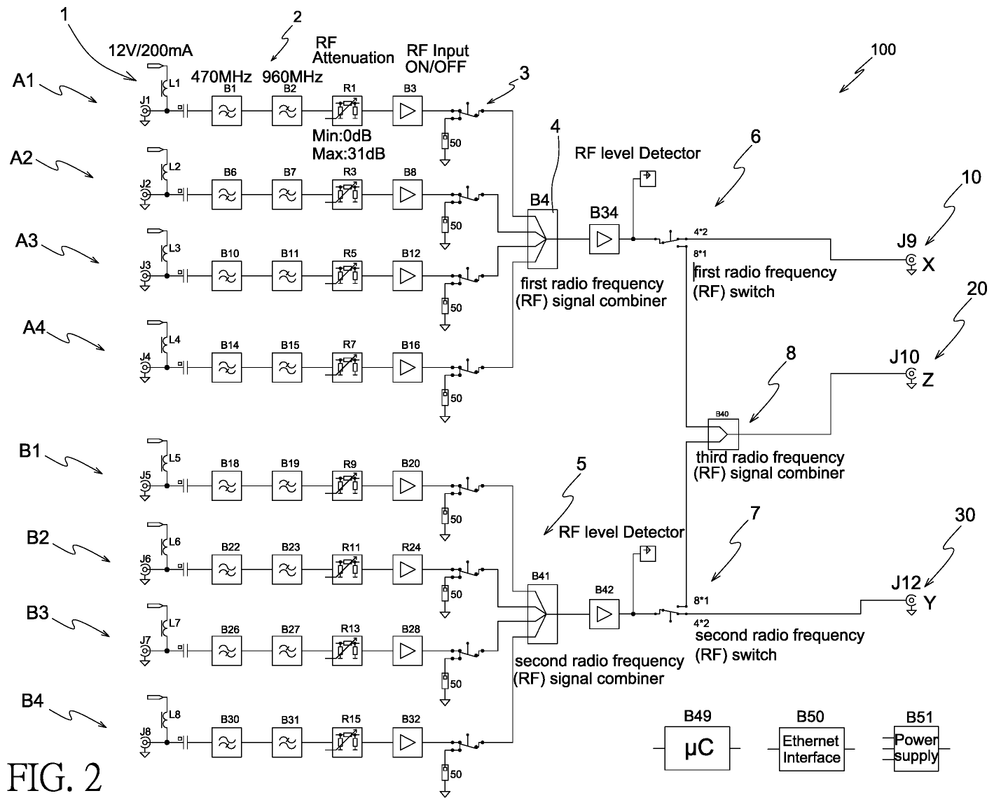

With reference to FIGS. 1-3, an antenna integration according to a first embodiment of the present invention is applicable for a wireless microphone, a wireless teaching system, and a wireless tour guide system of ultra-high frequencies. The antenna integration comprises an antenna integrator 100 including:
multiple antenna input ends 9 arranged in the antenna integrator 100 and configured to input radio frequency (RF) signals of multiple pairs of antennas.

For example, four pairs of antennas are provided in the antenna integration. The four pairs of antennas are a first antenna A1 and a second antenna A2, a third antenna A3 and a fourth antenna A4, a fifth antenna B1 and a sixth antenna B2, and a seventh antenna B3 and an eighth antenna B4 respectively. The first antenna A1, the second antenna A2, the third antenna A3, and the fourth antenna A4 are connected on a first connection position where a first radio frequency (RF) signal combiner 4 is arranged, and an end of the first RF signal combiner 4 is coupled with a first output end 10. The fifth antenna B1, the sixth antenna B2, the seventh antenna B3, and the eighth antenna B4 are connected on a second connection position where a second radio frequency (RF) signal combiner 5 is arranged, and an end of the second RF signal combiner 5 is coupled with a second output end 30 which is coupled with a predetermined audio receiver.

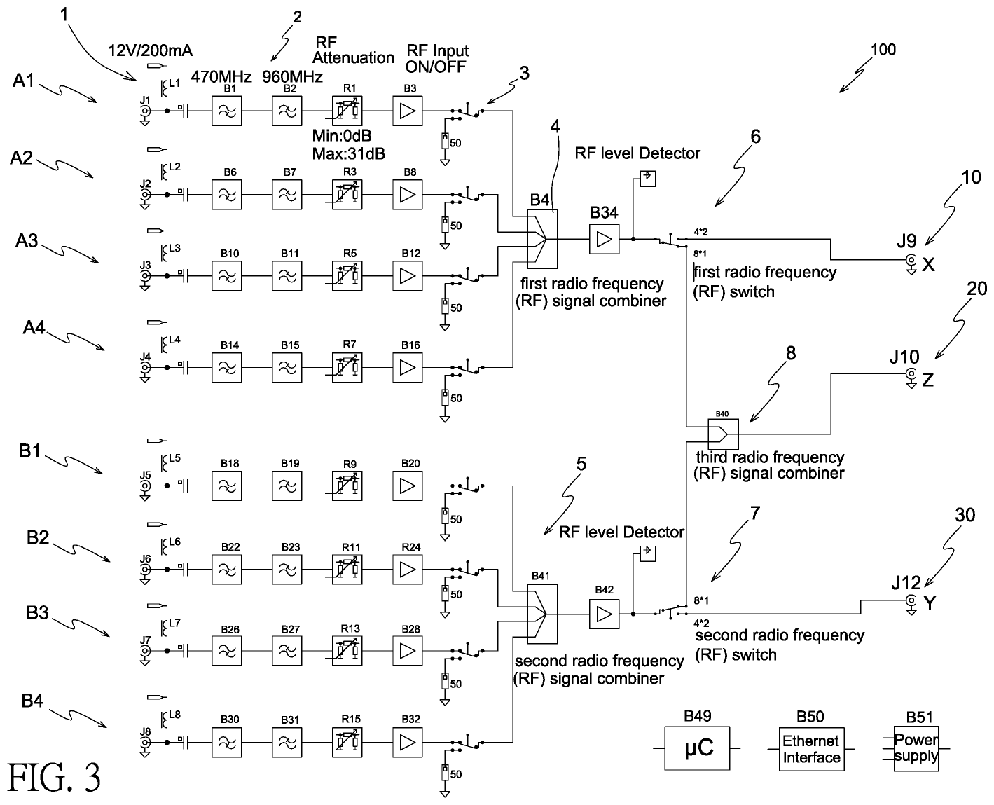

The first RF signal combiner 4 is coupled with a first radio frequency (RF) switch 6, and the second RF signal combiner 5 is coupled with a second radio frequency (RF) switch 7, wherein a third radio frequency (RF) signal combiner 8 is coupled with and is defined between the first RF signal combiner 6 and the second RF signal combiner 7, and the third RF signal combiner 8 is coupled with a second output end 20, such that the first RF switch 6 integrates and outputs the RF signals to the second output end 20 from the first antenna A1, the second antenna A2, the third antenna A3, and the fourth antenna A4, the second RF switch 7 integrates and outputs radio frequency (RF) signals to the second output end 20 from the fifth antenna B1, the sixth antenna B2, the seventh antenna B3, and the eighth antenna B4 (as shown in FIG. 3), and the second output end 20 is coupled with the predetermined audio receiver.

The antenna integrator 100 further includes a power control module 1 arranged in the antenna integrator 100 and configured to turn on/off a power supply to the multiple pairs of antennas;
multiple radio frequency (RF) attenuations 2 arranged in the antenna integrator 100 and configured to control an input of the RF signals; and
multiple radio frequency (RF) input ons/offs 3 arranged in the antenna integrator 100 and configured to turn on/off the RF signals.

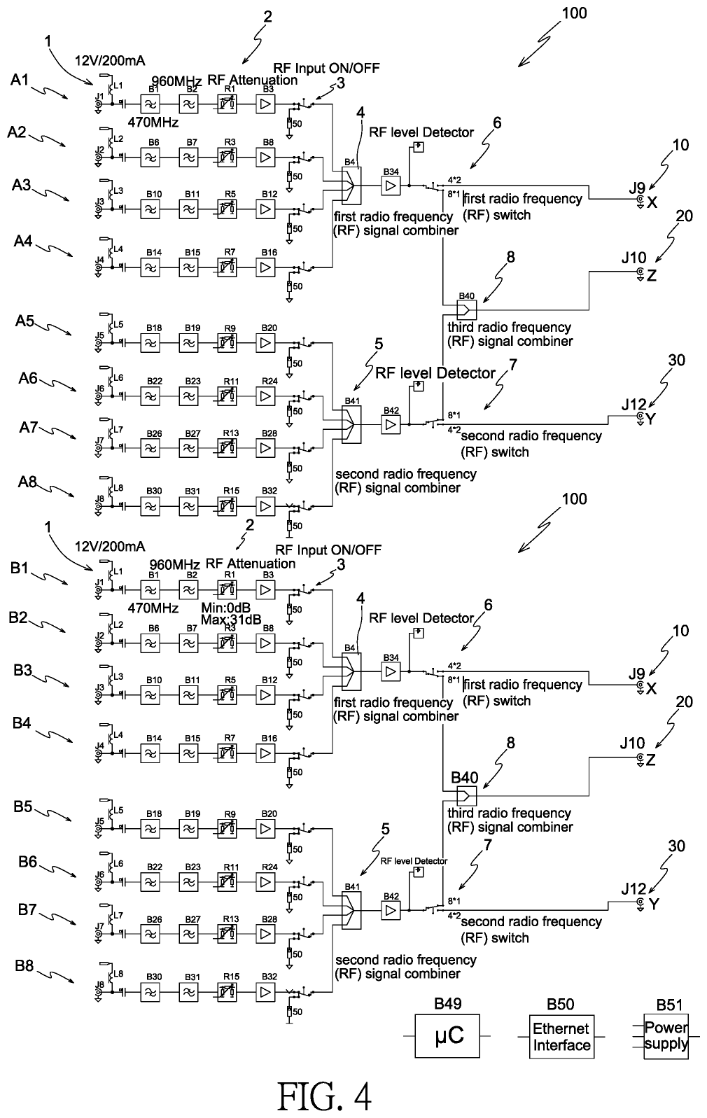

Referring to FIG. 4, a difference of a second embodiment from the first embodiment comprises: eight pairs of antennas which are a first antenna A1 and a second antenna A2, a third antenna A3 and a fourth antenna A4, a fifth antenna B1 and a sixth antenna B2, a seventh antenna B3 and an eighth antenna B4, a ninth antenna A5 and a tenth antenna A6, an eleventh antenna A7 and a twelfth antenna A8, a thirteenth antenna B5 and fourteenth antenna B6, and a fifteenth antenna B7 and a sixteenth antenna B8 respectively.

Thereby, the antenna integration of the present invention is capable of receiving wireless signals (i.e., the RF signals) sufficiently. Furthermore, the RF signals are declined easily and quickly by ways of the multiple RF input ons/offs 3 and the multiple RF attenuations 2.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. An antenna integration being applicable for a wireless microphone, a wireless teaching system, and a wireless tour guide system of ultra-high frequencies and comprising an antenna integrator including:
multiple antenna input ends arranged in the antenna integrator and configured to input radio frequency (RF) signals of multiple pairs of antennas;
a power control module arranged in the antenna integrator and configured to turn on/off a power supply to the multiple pairs of antennas;
multiple radio frequency (RF) attenuations arranged in the antenna integrator and configured to control an input of the RF signals; and
multiple radio frequency (RF) input ons/offs arranged in the antenna integrator and configured to turn on/off the RF signals.

2. The antenna integration as claimed in claim 1, wherein four pairs of antennas are provided in the antenna integration, the four pairs of antennas are a first antenna and a second antenna, a third antenna and a fourth antenna, a fifth antenna and a sixth antenna, and a seventh antenna and an eighth antenna respectively; the first antenna, the second antenna, the third antenna, and the fourth antenna are connected on a first connection position where a first radio frequency (RF) signal combiner is arranged, and an end of the first RF signal combiner is coupled with a first output end; and the fifth antenna, the sixth antenna, the seventh antenna, and the eighth antenna are connected on a second connection position where a second radio frequency (RF) signal combiner is arranged, and an end of the second RF signal combiner is coupled with a second output end.

3. The antenna integration as claimed in claim 2, wherein the first RF signal combiner is coupled with a first radio frequency (RF) switch, and the second RF signal combiner is coupled with a second radio frequency (RF) switch, wherein a third radio frequency (RF) signal combiner is coupled with and is defined between the first RF signal combiner and the second RF signal combiner, and the third RF signal combiner is coupled with a second output end, such that the first RF switch integrates and outputs the RF signals to the second output end from the first antenna, the second antenna, the third antenna, and the fourth antenna, the second RF switch integrates and outputs radio frequency (RF) signals to the second output end from the fifth antenna, the sixth antenna, the seventh antenna, and the eighth antenna.

4. The antenna integration as claimed in claim 1, wherein eight pairs of antennas are provided in the antenna integration, the eight pairs of antennas are a first antenna and a second antenna, a third antenna and a fourth antenna, a fifth antenna and a sixth antenna, a seventh antenna and an eighth antenna, a ninth antenna and a tenth antenna, an eleventh antenna and a twelfth antenna, a thirteenth antenna and fourteenth antenna, and a fifteenth antenna and a sixteenth antenna respectively.
